(19) United States
(12) Patent Application Publication
(10) Pub. No.: US 2026/0339060 A1
(43) Pub. Date: Oct. 29, 2026

(54) TETHERED FAP ASSEMBLY

(71) Applicant: Panduit Corp., Tinley Park, IL (US)

(72) Inventor: Alex C. Brouwer, New Lenox, IL (US)

(73) Assignee: Panduit Corp., Tinley Park, IL (US)

(21) Appl. No.: 19/188,104

(22) Filed: Apr. 24, 2025

(51) Int. Cl. G02B 6/44

(52) U.S. Cl. CPC G02B 6/4471

(57) ABSTRACT

A tethered FAP assembly has a trunk cable assembly, a plurality of connectors connected to the trunk cable assembly, a plurality of FAPs attached to the connectors and trunk cable assembly wherein each FAP has a FAP base and a cable hold down to secure cables of the trunk assembly to the FAP base. In one embodiment, the tethered FAP assembly can further include fasteners the secure the plurality of FAPs together to aid in pulling the tethered FAP assembly in an overhead pathway.

### FIELD OF INVENTION

The present invention relates generally to tethered assemblies and more specifically to a tethered fiber adapter panel (FAP) assembly that allows the FAPs to be connected together to aid in pulling though an overhead pathway.

### BACKGROUND

It would be beneficial to have tethered assemblies cleaned, connected, and tested before leaving the factory, reducing potential quality issues for the customer. However, such an assembly can be difficult to pull though overhead pathways. Connecting four FAPs to a single trunk and connecting the FAPs together also allows the customer to pull more connectivity through the overhead pathway in a single pull versus pulling four FAPs individually, thus saving time.

A tethered FAP assembly has a trunk cable assembly, a plurality of connectors connected to the trunk cable assembly, a plurality of FAPs attached to the connectors and trunk cable assembly wherein each FAP has a FAP base and a cable hold down to secure cables of the trunk assembly to the FAP base. In one embodiment, the tethered FAP assembly can further include fasteners the secure the plurality of FAPs together to aid in pulling the tethered FAP assembly in an overhead pathway.

### BRIEF DESCRIPTION OF THE DRAWINGS

FIG. 1 shows an isometric view of a tethered FAP assembly.

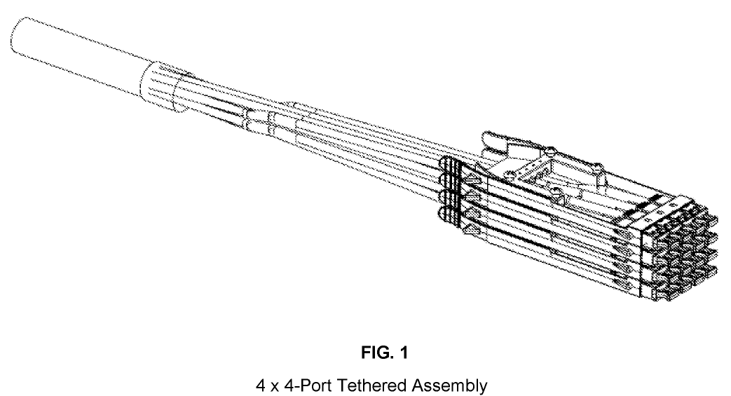

FIG. 2 shows the assembly of FIG. 1 without the FAPs attached.

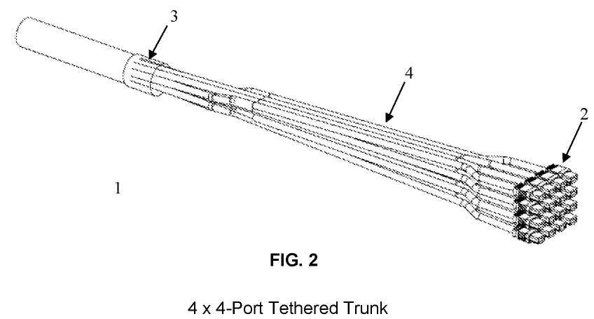

FIG. 3 shows an exploded isometric view of a FAP.

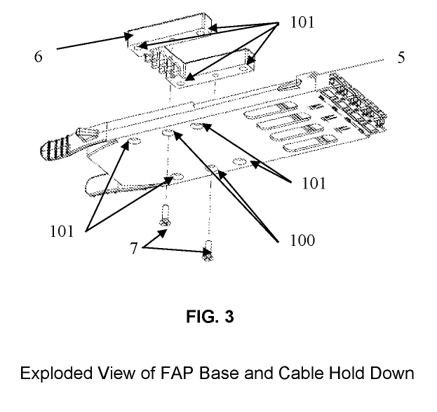

FIG. 4 is an isometric view showing how the terminated cable assembly can be secured to the FAP.

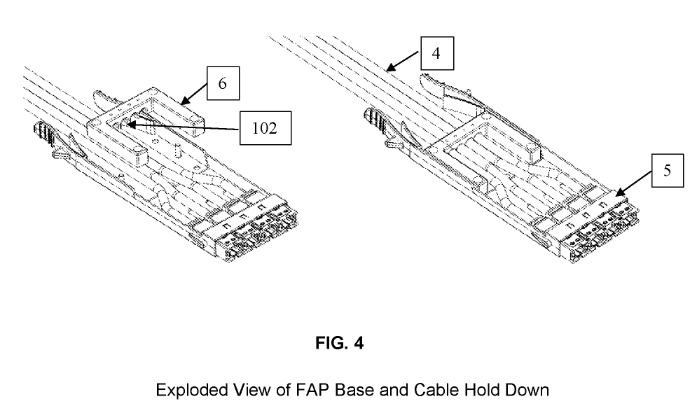

FIG. 5 shows how the FAPs can be connected together to aid in pulling though an overhead pathway.

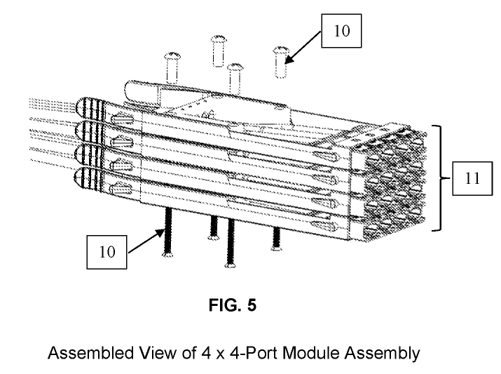

### DESCRIPTION OF THE INVENTION

This record sketch describes a high-fiber count trunk assembly that is tethered/connected to four 4-port MPO FAPs to make a new assembly. This assembly can have FAPs on both ends of the trunk or have a FAP on one end and MPO connectors on the other end. This tethered assembly provides benefit to the customer in that the trunk and MPO adapter are cleaned, connected, and tested before leaving the factory, reducing potential quality issues for the customer. Connecting four FAPs to a single trunk and connecting the FAPs together also allows the customer to pull more connectivity through the overhead pathway in a single pull versus pulling four FAPs individually, thus saving time

The 4 x 4-port tethered assembly can use existing 288 Fiber Trunks 1. The 288 fiber trunk will have sixteen MPO-16 connectors 2. These MPO-16 connectors 2 will breakout from the transition 3. Furcation tube 4 is used to protect the fiber between the transition and the MPO-16 connectors 2. In one embodiment, only 256 of the 288 fibers would be used in the tethered assembly. The additional 32 fibers will either be dark (non-terminated) or could be terminated with MPO-16 connectors and used as spare connectors in the future, should damage to a connector/cable occur.

The furcation tubes 4 will be secured to the FAP base 5 using a cable hold down 6. The FAP base has holes 100 placed into the bottom, either molded or machined. The cable hold down is installed inside the FAP base with fasteners 7 to secure the furcation tubes. The cable hold down could be molded or machined. The FAP base and cable hold down have additional clearance holes 101 to allow attaching the four FAP assemblies together.

The cable hold down 6 has semi-circles 102 which allow the furcation tubes 4 to pass through, but have an interference fit to clamp the furcation tubes to the FAP Base 5 when secured together.

Fasteners 10 could be inserted through all four FAP Bases 5 and cable hold downs 6 to secure them together to create a module assembly 11. This would allow the user to pull the assembly through an overhead pathway as a single unit, instead of having to pull four individual assemblies.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tethered fiber adapter panel (FAP) assembly comprising:
a trunk cable assembly;
a plurality of connectors terminated to the trunk cable assembly;
a plurality of FAPs attached to the connectors and trunk cable assembly wherein each FAP has a FAP base and a cable hold down to secure cables of the trunk assembly to the FAP base.

2. The tethered FAP assembly of claim 1, further comprising fasteners to secure the plurality of FAPs together to aid in pulling the tethered FAP assembly in an overhead pathway.
